(19) United States
(12) Patent Application Publication
(10) Pub. No.: US 2004/0184259 A1
(43) Pub. Date: Sep. 23, 2004

(54) Luminescent signage component

(76) Inventor: Ivan To, Drayton Valley (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/803,012

(22) Filed: Mar. 16, 2004

(30) Foreign Application Priority Data
Mar. 18, 2003 (CA) 2,422,383

(51) Int. Cl. F21V 9/16

(52) U.S. Cl. 362/84

(57) ABSTRACT

A luminescent signage component which includes a body having at least one cavity. Luminescent epoxy fills the at least one cavity. The luminescent epoxy in the cavity emits a luminescent glow in the event of a power failure.

### FIELD OF THE INVENTION

The present invention relates to a luminescent signage component suited for use in any type of signage, and having particular utility for indicating the position of an exit door in the case of an emergency, such as a fire.

### BACKGROUND OF THE INVENTION

Building codes in most jurisdictions require that exit doors be clearly marked, so that the public will be able to rapidly identify the exit doors in the case of an emergency, such as a fire. Whatever exit markings are provided, must be remain clearly visible in the event of a power outage. Depending upon the jurisdiction, the time period prescribed may vary. The time period is usually at least 45 minutes. In the past, the continued illumination of the exit markings in the event of a power outage has been addressed with an auxiliary power source. Persons have suggested the use of luminescent signage. An example of this is U.S. Pat. No. 6,358,653 (van Duynhoven 2002). The van Duynhoven patent teaches marking luminescent indicia using a stencil and luminescent paint. A possible concern about the teachings of the van Duynhoven patent is whether there is sufficient luminescent material in the paint to maintain the indicia illuminated for the length of time required.

### SUMMARY OF THE INVENTION

What is required is an alternative form of luminescent signage component.

According to the present invention there is provided a luminescent signage component which includes a body having at least one cavity. Luminescent epoxy fills the at least one cavity. The luminescent epoxy in the cavity emits a luminescent glow in the event of a power failure.

It is preferred that the at least one cavity defines a message conveying indicia, such as a series of alpha-numeric characters or a graphic symbol. With the luminescent signage component, as described above, luminescent epoxy fills the cavity in the body. This approach substantially increases the amount of luminescent material and, consequently, the time duration during which the luminescent material will continue to glow, as compared to the van Duynhoven patent reference.

Although beneficial results may be obtained through use of the luminescent signage components, as described above, to this point the technology has not been able to supplant traditional backlit exit signs. Even more beneficial results may, therefore, be obtained when a portion of the body where the cavity or cavities are positioned is transparent. This enables the luminescent epoxy to be backlit by a light positioned behind the body. The backlit luminescent epoxy will be charged by the light positioned behind the body. Should the light go out due to a power failure, the fully charged luminescent epoxy will glow, so that there will be little or no perceived difference in operation to the public.

Although beneficial results may be obtained through use of the luminescent signage components, as described above, when the cavity or cavities are recesses made in dark material, the dark material tends to absorb light and reduce the time it takes to charge the luminescent epoxy. Even more beneficial results may, therefore, be obtained when the cavities have a light reflecting coating to facilitate charging of the luminescent epoxy by a light positioned in front of the body. Beneficial results have been obtained through the use of a white paint.

It is envisaged that the body will take the form of a sign plate in most cases. However, there may be advantages in making the exit door stand out by having the body in the form of a door molding. In such a case, the luminescent epoxy of the door molding will glow to assist the public in finding the exit door. There may also be advantages in having the body take the form of a chair rail molding. In such a case, the luminescent epoxy of the chair rail molding will glow. If appropriate graphic indicia, such as arrows, were used; the glowing indicia on the chair rail molding could point the way to the exit door.

Although beneficial results may be obtained through the use of the luminescent signage components, as described above, even more beneficial results may be obtained when the body is a transparent tubular body and the cavity is an axially extending bore filled with luminescent epoxy.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a detailed side elevation view, in section, of a luminescent signage component constructed in accordance with the teachings of the present invention, having a cavity in a transparent body portion.

FIG. 2a is a detailed side elevation in section of a luminescent signage component constructed in accordance with the teachings of the present invention, where the cavities are in dark material.

FIG. 2b is a front elevation view of the luminescent signage component illustrated in FIG. 2a.

FIG. 3a is a detailed side elevation view, in section, of a luminescent signage component constructed in accordance with the teachings of the present invention, where the body is in the form of a molding.

FIG. 3b is a perspective view of the luminescent signage component as illustrated in FIG. 3a where the moldings are in a public setting.

FIG. 4, labelled as PRIOR ART is a perspective view with partial cutaway of a traditional backlit exit sign.

FIG. 5 is a perspective view of an alternative tubular embodiment of luminescent signage component.

### DETAILED DESCRIPTION OF THE PREFERRED EMBODIMENT

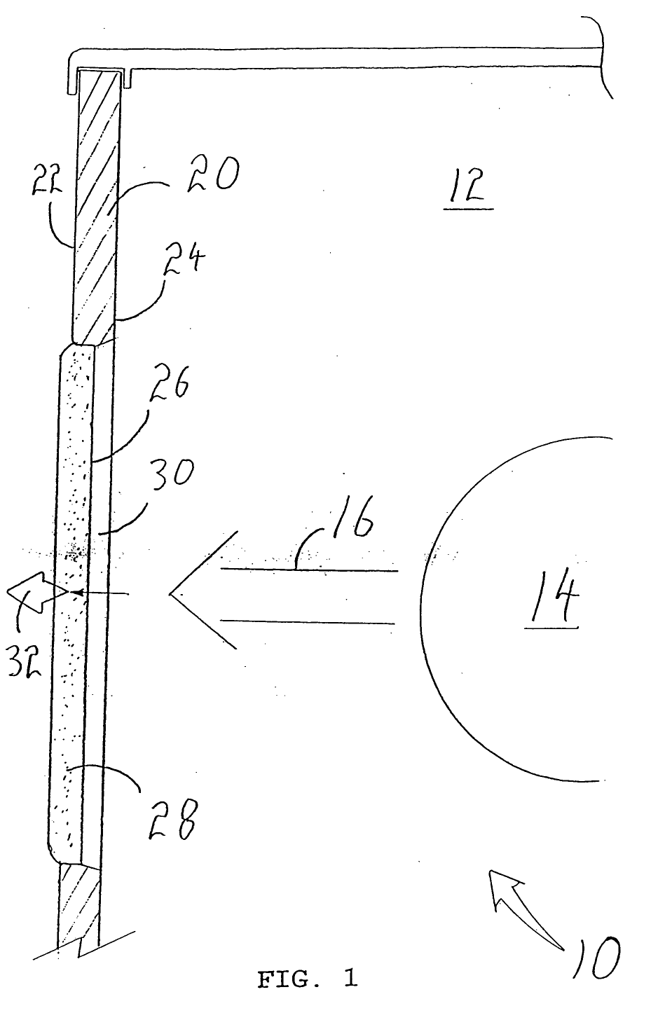

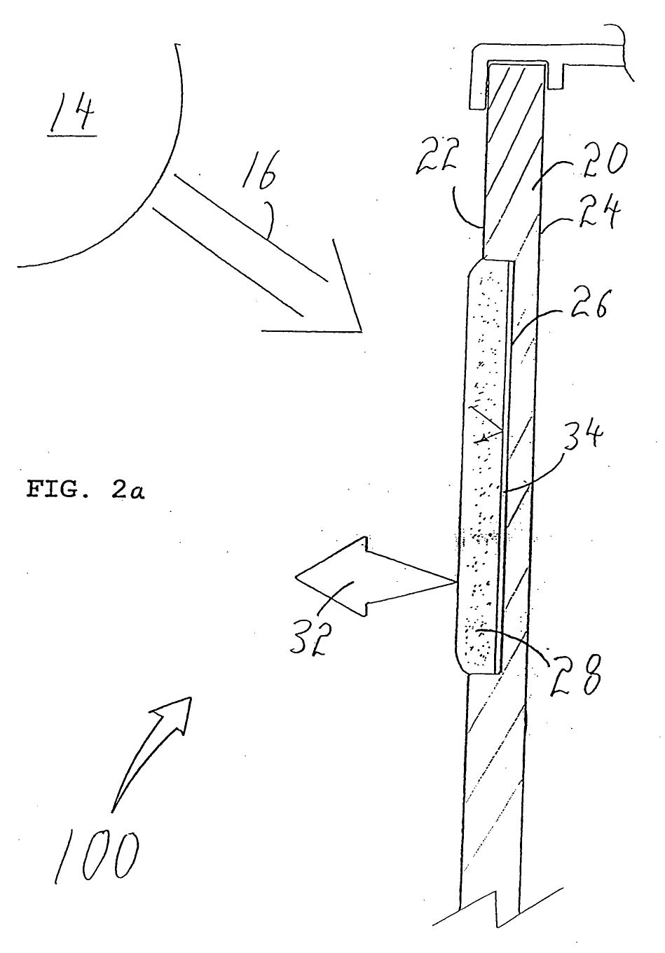

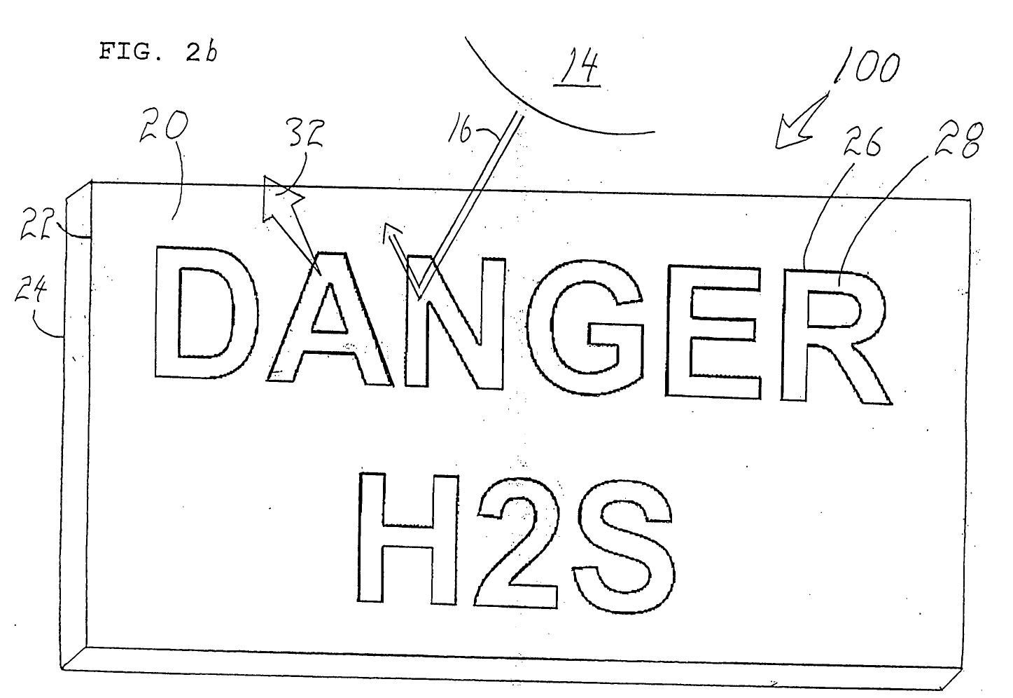

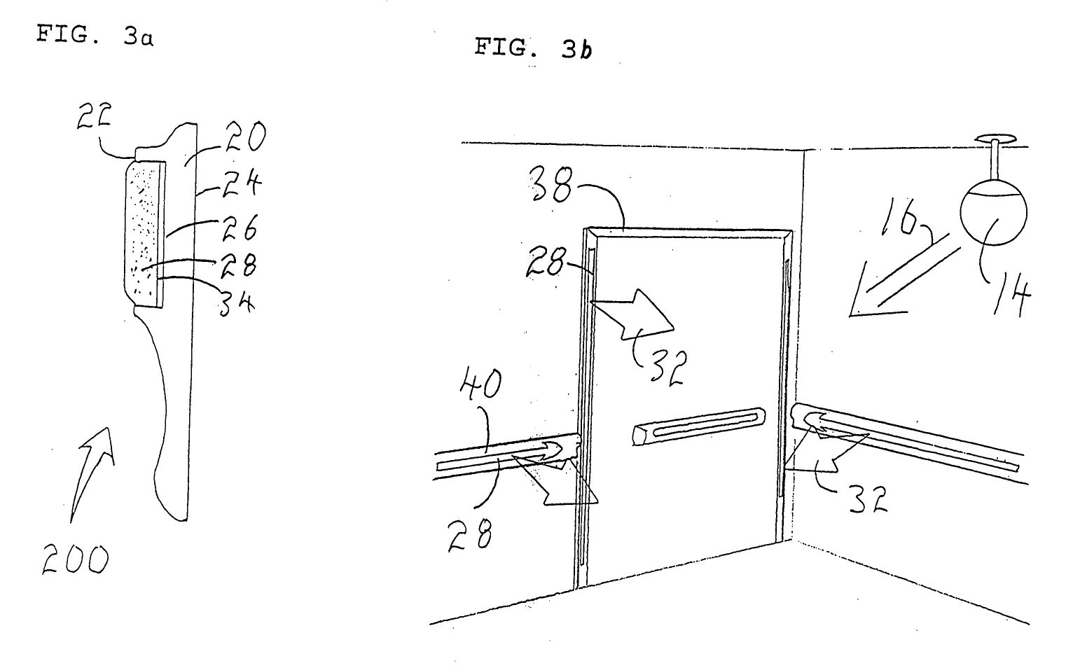

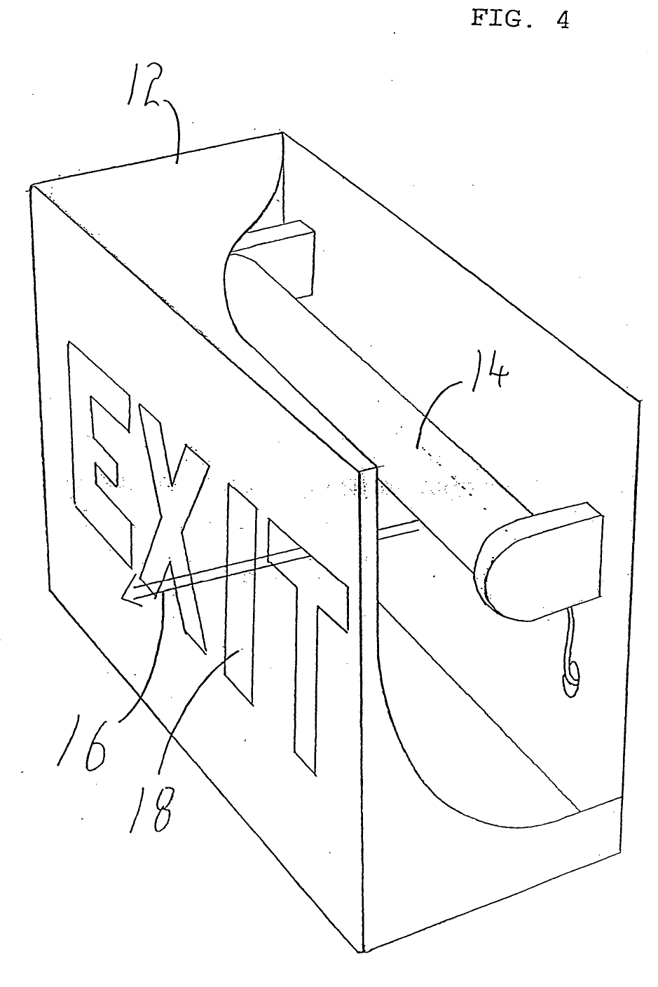

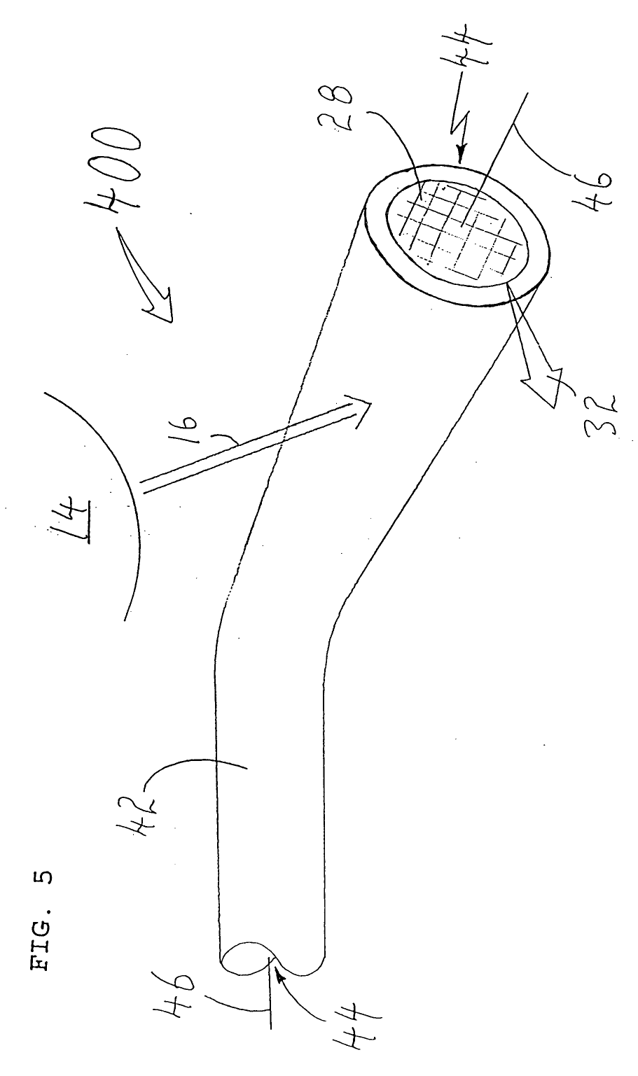

Three preferred embodiments of luminescent signage components will now be described. A first embodiment of luminescent signage component, generally indicated by reference numeral 10 will be described with reference to FIG. 1. A second embodiment of luminescent signage component, generally indicated by reference numeral 100 will be described with reference to FIGS. 2a and 2b. A third embodiment of luminescent signage component, generally indicated by reference numeral 200 will be described with reference to FIGS. 3a and 3b. A fourth embodiment of luminescent signage component, generally indicated by reference numeral 400 will be described with reference to FIG. 5.

In order to place the present invention in context there will first be described a traditional backlit exit sign system. Referring to FIG. 4, a standard exit sign has an enclosure 12 with a light source 14. Radiant light 16 from light source 14 passes through translucent indicia 18 indicating to occupants the necessary information. Without backup power, when light source 14 fails, the sign fails.

Structure and Relationship of Parts of the First Embodiment:

Referring to FIG. 1, luminescent signage component 10 has a body 20 having a first face 22 and a second face 24. In the illustrated embodiment, body 20 is in the form of a sign plate. A cavity 26, defining indicia, is formed out of body 20 on first face 22. Luminescent epoxy 28 fills cavity 26. Body 20 is adapted with a transparent portion 30 where cavity 26 is formed. A light source 14 is oriented within an enclosure 12 to shine on second face 24. Radiant light 16 from light source 14 shines through transparent portion 30 striking luminescent epoxy 28, charging and illuminating the indicia.

Operation:

The use and operation of luminescent signage component 10 will now be described with reference to FIG. 1. Under normal conditions, light source 14 will be powered, illuminating the alpha-numeric characters on front face 22 that is defined by luminescent epoxy 28 within cavity 26. However, a key advantage of the preferred embodiment is that radiant light 16, by passing through transparent portion 30, also stimulates and charges luminescent epoxy 28. In the event there is a power failure, luminescent epoxy 28 continues to emit luminescent light 32, without the aid of backup power. Further, as there is substantially more luminescent epoxy within cavity 24, the effective life of luminescent light 32 is much longer, being a practical alternative to backup power.

Structure and Relationship of the Parts of the Second Embodiment:

Referring to FIGS. 2a and 2b, luminescent signage component 100 has a body 20 having a first face 22 and a second face 24. In the illustrated embodiment, body 20 is in the form of a sign plate. A cavity 26, defining indicia in the form of alpha-numeric characters, is formed out of body 20 on first face 22. Luminescent epoxy 28 fills cavity 26. Body 20 is adapted with a reflective coating 34 positioned at the base of cavity 26, behind luminescent epoxy 28. Radiant light 16 from a light source 14, situated so as to shine on first face 22, passes through luminescent epoxy 28 and reflects off of reflective coating 34.

Operation:

The use and operation of luminescent signage component 100 will now be described with reference to FIGS. 2a and 2b. Under normal conditions, light source 14 will be powered, casting light on the indicia at front face 22 that is defined by luminescent epoxy 28 within cavity 26. However, a key advantage of the second preferred embodiment is that radiant light 16, by passing through luminescent epoxy 28, reflecting off reflective coating 34 and re-entering luminescent epoxy 28 not only brightens the indicia under normal conditions, but also stimulates and charges luminescent epoxy 28. In the event there is a power failure, luminescent epoxy 28 continues to emit luminescent light 32, without the aid of backup lighting. Further, as there is substantially more luminescent epoxy within cavity 24, the effective life of luminescent light 32 is much longer, being a practical alternative to backup lighting.

Structure and Relationship of the Parts of the Third Embodiment:

Referring to FIG. 3a, luminescent signage component 200 has a body 20, first face 22, second face 24, cavity 26, luminescent epoxy 28 and reflective coating 34 as illustrated in FIGS. 2a and 2b. However, in the illustrated embodiment, body 20 is in the form of a molding. Referring to FIG. 3b, a typical exit situation in a public place may have door moldings 38 and chair rail moldings 40. Each molding has a luminescent epoxy 28. A light source 14 provides radiant light 16 to illume and charge each indicia defined by each luminescent epoxy 28.

Operation:

The use and operation of luminescent signage component 200 will now be described with reference to FIGS. 3a and 3b. Under normal conditions, light source 14 will be powered, casting light on the indicia at front face 22 that is defined by luminescent epoxy 28 within cavity 26. In the illustrated embodiment, in the event of a power failure, luminescent light 32 is emitted from luminescent epoxy 28, effectively and persistently directing patrons or other occupants to an exit.

Structure and Relationship of the Parts of the Fourth Embodiment:

Referring to FIG. 5, luminescent signage component 400 has a transparent tubular body 42 having a cavity 44 and an axially extending bore 46. Luminescent epoxy 28 is encapsulated by cavity 44 along axially extending bore 46, such that luminescent light 32 is emitted through transparent tubular body 42.

Operation:

The use and operation of luminescent signage component 400 will now be described with reference to FIG. 5. In the illustrated embodiment, transparent tubular body 42 is flexible, made out of a transparent PVC Vinyl. This allows transparent tubular body 42 to be formed into indicia. It will be appreciated that other Polycarbonate or Acrylic materials are available for use. Once luminescent epoxy 28 is injected into cavity 44, it can be charged with radiant light 16 from a light source 14. In the event of a power failure, luminescent light 32 is then emitted from luminescent epoxy 28 through transparent tubular body 42 displaying the desired indicia.

In describing all four embodiments of the invention, reference has been made to “luminescent epoxy”. The epoxy is composed of a resin and a hardener or activator. The luminescent material is composed of alkaline earth metal aluminum oxide doped with europium. Both the epoxy and the luminescent material are chemically and physically stable and environmentally friendly. The two materials combine to create a luminescent epoxy. The luminescent epoxy is used to fill the cavities in the selected body accordance with the first, second, third or fourth embodiment. The luminescent epoxy then hardens to become tough and durable, with the luminescent material suspended within the epoxy.

Having regard to the embodiment illustrated and described in FIG. 1, it is believed that the combination of luminescence in a conventional exit sign housing is unique. Once the teachings of the present invention are understood, it may be possible to retrofit thousands of conventional exit signs to include luminescence. The inlaying of the luminescence material, as described above, is to be preferred because it greatly increases the strength of the luminescence. However, beneficial results may be obtained even if a luminescent overlay is used instead of an inlay.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A luminescent signage component, comprising:
a body;
at least one cavity in the body;
luminescent epoxy filling the at least one cavity, such that the luminescent epoxy in the at least one cavity emits a luminescent glow in the event of a power failure.

2. The luminescent signage component as defined in claim 1, wherein the at least one cavity defines a message conveying indicia.

3. The luminescent signage component as defined in claim 2, wherein the message conveying indicia is one of series of alpha-numeric characters or a graphic symbol.

4. The luminescent signage component as defined in claim 1, wherein the body is a transparent tubular body and the cavity is an axially extending bore filled with luminescent epoxy.

5. The luminescent signage component as defined in claim 1, wherein a portion of the body where the at least one cavity is positioned is transparent, thereby enabling the luminescent epoxy to be backlit by a light positioned behind the body.

6. The luminescent signage component as defined in claim 1, wherein the at least one cavity has a light reflecting coating, thereby facilitating charging of the luminescent epoxy.

7. The luminescent signage component as defined in claim 6, wherein the light reflecting coating is a white paint.

8. The luminescent signage component as defined in claim 1, wherein the body is a sign plate.

9. The luminescent signage component as defined in claim 1, wherein the body is one of a door molding or chair rail molding.

10. A luminescent signage component, comprising:
a body in the form of a sign plate;
at least one cavity in the body defining one of alpha-numeric indicia or graphic indicia;
luminescent epoxy filling the at least one cavity, such that the one of alpha-numeric indicia or graphic indicia emit a luminescent glow in the event of a power failure; and
a portion of the body where the at least one cavity is positioned being transparent, thereby enabling the luminescent epoxy to be backlit by a light positioned behind the body.

11. A luminescent signage component, comprising:
a body in the form of a molding;
at least one cavity in the body;
luminescent epoxy filling the at least one cavity, such that the luminescent epoxy emits a luminescent glow in the event of a power failure, and
the at least one cavity having a light reflecting coating, thereby facilitating charging of the luminescent epoxy.

12. The luminescent signage component as defined in claim 11, wherein the molding is a door molding for an exit door.

13. The luminescent signage component as defined in claim 11, wherein the molding is a chair rail molding with graphic indicia adapted to point toward an exit door.

14. A luminescent signage component, comprising:
a transparent tubular body;
a cavity in the body in the form of an axially extending bore;
luminescent epoxy filling the cavity, such that the luminescent epoxy emits a luminescent glow through the transparent tubular body in the event of a power failure.

15. An exit sign, comprising:
a sign enclosure;
a light mounted in the enclosure;
a sign plate mounted in the enclosure, the sign plate bearing letters spelling the word EXIT, the letters being formed with a luminescent material, the sign plate being backlit by the light, such that the light illuminates the letters and activates the luminescent material so that the letters EXIT give off a luminescent glow making them visible when power to the light is disrupted.

16. The exit sign as defined in claim 15, wherein the sign plate has at least one cavity forming letters, the cavity being filled with luminescent material.
